(19) United States
(12) Patent Application Publication
(10) Pub. No.: US 2025/0055015 A1
(43) Pub. Date: Feb. 13, 2025

(54) WINDING APPARATUS

(71) Applicant: CKD CORPORATION, Aichi (JP)

(72) Inventors: Takanori Yagi, Aichi (JP); Yusuke Yamaguchi, Aichi (JP)

(73) Assignee: CKD CORPORATION, Aichi (JP)

(21) Appl. No.: 18/760,492

(22) Filed: Jul. 1, 2024

(30) Foreign Application Priority Data
Aug. 9, 2023 (JP) 2023-130263

(51) Int. Cl. H01M 10/04; H01M 50/538

(52) U.S. Cl. CPC H01M 10/0409; H01M 50/538

(57) ABSTRACT

A winding apparatus winds up a belt-shaped electrode sheet and a belt-shaped separator sheet, and includes: a rotatable winding core to which the electrode sheet and the separator sheet are fed at accelerating or decelerating speed, and around which the electrode sheet and the separator sheet are wound; a rotatable transfer roller that defines a transfer path of the electrode sheet and has an outer circumference face on which the electrode sheet is placed; and a position adjustment unit that adjusts a position of the transfer roller along a rotation axis direction of the transfer roller. The position adjustment unit adjusts a relative positional relationship between the transfer roller and the electrode sheet placed thereon such that a trough portion of the electrode sheet protrudes from a width direction edge portion in the outer circumferential face of the transfer roller.

### BACKGROUND

### Technical Field

The present disclosure relates to a winding apparatus configured to provide, for example, a winding element that is built in a secondary battery or the like.

### Description of Related Art

For example, a winding element used for a secondary battery, such as a lithium-ion battery, is manufactured by winding a cathode sheet (positive electrode sheet) with a cathode active material (positive electrode active material) applied thereon and an anode sheet (negative electrode sheet) with an anode active material (negative electrode active material) applied thereon, which are overlaid one upon the other via a separator sheet made of an insulating material.

A known configuration of the electrode sheet includes an electrode main body with an active material applied on a surface thereof, and tabs protruded from a width direction edge portion of the electrode main body. The tabs are disposed at intervals along a longitudinal direction of the electrode main body.

A known configuration of a winding apparatus used to manufacture the winding element includes a rotatable winding core; and a feed mechanism configured to feed the electrode sheets and the separator sheet to the winding core. Such a winding apparatus is provided with a transfer roller that is freely rotatable and that causes an electrode sheet or the like to be placed thereon. The transfer roller serves to define or specify a transfer path of the electrode sheet or the like.

When the electrode sheet having the tabs passes through the transfer roller, the tabs are likely to be bent or broken. A technique of providing a deformation preventive member at a position of the transfer roller corresponding to an entrance of the electrode sheet has been proposed, with a view to dealing with the possibility that the tabs are bent or broken (as described in, for example, Patent Literature 1). The deformation preventive member is provided in such a state as to be separated from an outer circumferential face on one end in a width direction of the transfer roller. The configuration of guiding the tabs between the deformation preventive member and the transfer roller aims to prevent the tabs from being bent or broken.

### PATENT LITERATURE

Patent Literature 1: Japanese Patent No. 2016-35892A

As a result of intensive studies, the inventors of the present disclosure have found the following factors as the cause of bending or breaking the tabs.

In the process of winding the electrode sheet, the electrode sheet is not transferred continuously at a constant speed but is transferred at accelerating or decelerating speed. Such acceleration and deceleration of the electrode sheet cause vibration or resonance in the electrode sheet and thereby cause the tabs to swingingly move along a thickness direction of the electrode sheet. The swingingly moving tabs are likely to collide with the outer circumferential face of the transfer roller. This may cause jumping of the tabs and, as a result, cause the tabs to be bent or broken.

The technique described in Patent Literature 1, however, does not at all solve the problem of causing the tabs to collide with the outer circumferential face of the transfer roller and to be jumped. Furthermore, the jumped tabs are likely to hit against the deformation preventive member. This may lead to deformation or damage of the tabs.

### SUMMARY

By taking into account the circumstances described above, one or more embodiments of the present disclosure provide a winding apparatus that more certainly prevents collision of tabs with an outer circumferential face of a transfer roller and that effectively prevents the tabs from being bent or broken.

The following describes each of various aspects of the present disclosure. Functions and advantageous effects that are characteristic of each of the aspects are also described as appropriate.

Aspect 1. There is provided a winding apparatus that winds up a belt-shaped electrode sheet including an active material and a belt-shaped separator sheet made of an insulating material. The winding apparatus comprises: a rotatable winding core to which the electrode sheet and the separator sheet are fed at accelerating or decelerating speed, and around which the electrode sheet and the separator sheet are wound; a rotatable transfer roller that defines a transfer path of the electrode sheet and has an outer circumference face on which the electrode sheet is placed; and a position adjustment unit that adjusts a position of the transfer roller along a rotation axis direction of the transfer roller. The electrode sheet comprises: an electrode main body on which the active material is applied; tabs protruded from a width direction edge portion of the electrode main body and disposed at intervals along a longitudinal direction of the electrode main body; and a trough portion disposed between the tabs at the width direction edge portion. The position adjustment unit adjusts a relative positional relationship between the transfer roller and the electrode sheet placed on the transfer roller such that the trough portion protrudes from a width direction edge portion in an outer circumferential face of the transfer roller.

In the winding apparatus of above Aspect 1, the electrode sheet is fed to the winding core at accelerating or decelerating speed. This causes the tabs to swingingly move due to the generation of vibration or resonance accompanied with the acceleration or the deceleration of the electrode sheet. As a result, the tabs are likely to collide with the outer circumferential face of the transfer roller and are likely to be bent or broken.

The winding apparatus of above Aspect 1, however, includes the position adjustment unit configured to adjust the position of the transfer roller along the direction of the rotation axis of the transfer roller. The transfer roller is set such that the trough portion that is the width direction edge portion of the electrode main body and that is the portion located between the tabs is protruded from the width direction edge portion in the outer circumferential face of the transfer roller, when this position adjustment unit is used to regulate the relative positional relationship between the transfer roller and the electrode sheet. Accordingly, the transfer roller is set such that the entire tabs of the electrode sheet placed on the transfer roller are present at a position deviated from the outer circumferential face of the transfer roller, when the transfer roller is viewed from a direction orthogonal to the rotation axis of the transfer roller. This configuration more certainly prevents collision of the tabs with the outer circumferential face of the transfer roller, even when the tabs swingingly move. As a result, this configuration suppresses jumping of the tabs caused by the collision of the tabs with the outer circumferential face of the transfer roller and thereby effectively prevents the tabs from being bent or broken.

Preventing the collision of the tabs with the outer circumferential face of the transfer roller, in combination with preventing the tabs from being bent or broken, enables the tabs to be kept in good conditions with less damages. This accordingly improves the quality of the winding element obtained.

Furthermore, the configuration of providing the position adjustment unit allows for handling of various electrode sheets having different widths or the like and thereby enhances the convenience.

Aspect 2. The winding apparatus described in above Aspect 1 may further comprise a position detection unit (i.e., edge sensor) that detects a position in a width direction of the electrode sheet placed on the transfer roller; and a correction unit that corrects a positional misalignment in the width direction of the electrode sheet while the electrode sheet is being wound on the winding core, based on the position detected by the position detection unit, wherein the position detection unit and the correction unit may maintain a state in which the trough portion protrudes from the width direction edge portion in the outer circumferential face of the transfer roller.

In the winding apparatus of above Aspect 2, the position detection unit and the correction unit serve to maintain the state that the trough portion is protruded from the width direction edge portion in the outer circumferential face of the transfer roller. Accordingly, this configuration more certainly prevents collision of the tabs with the outer circumferential face of the transfer roller. This further enhances the effect of preventing the tabs from being bent or broken and further improves the conditions of the tabs.

Aspect 3. In the winding apparatus described in above Aspect 1, the electrode sheet is placed on the transfer roller after being transferred in a horizontal direction or in an oblique horizontal direction at a position immediately upstream of the transfer roller along a transfer direction of the electrode sheet.

In the winding apparatus of above Aspect 3, the electrode sheet is transferred in the horizontal direction or in the oblique horizontal direction at the position immediately upstream of the transfer roller. This makes the tabs of the electrode sheet more likely to sag at the position immediately upstream of the transfer roller and increases the possibility of collision of the tabs with the outer circumferential face of the transfer roller.

Employing the configuration of above Aspect 1 more certainly prevents the collision of the tabs with the transfer roller even under the condition that the tabs are more likely to sag as in the case of above Aspect 3. In other words, the configuration of above Aspect 1 is especially effective for the transfer roller configured such that the electrode sheet is placed on the transfer roller after being transferred in the horizontal direction or in the oblique horizontal direction at the position immediately upstream of the transfer roller.

Aspect 4. In the winding apparatus described in above Aspect 1, the tabs may be formed by cutting a belt-shaped electrode sheet material on which an active material is applied, and the trough portion may be configured by a cut surface of the electrode sheet.

In the winding apparatus of above Aspect 4, the tabs are formed by the cutting process of cutting the electrode sheet material by using laser, a die or the like, and the trough portion is configured by the cut surface formed by the cutting process. The trough portion is thus likely to be rough (in a state having burrs or the like).

Employing the configuration of above Aspect 1 more certainly prevents a rough part (for example, burrs or the like) from running on the outer circumferential face of the transfer roller, even when the trough portion is in the rough state. This configuration more certainly prevents the tabs from being bent or broken due to the rough part running on the outer circumferential face of the transfer roller. As a result, this further enhances the effect of preventing the tabs from being bent or broken.

Additionally, this configuration does not require any additional process of removing the rough part from the trough portion (the cut surface), with a view to preventing the rough part from running on the outer circumferential face of the transfer roller. This reduces, for example, the cost required for manufacture of the winding element.

Aspect 5. In the winding apparatus described in above Aspect 1, the transfer roller may be supported in a cantilevered state only on one end in the rotation axis direction, the one end being on an opposite side to a side where the tabs are located.

In the winding apparatus of above Aspect 5, the transfer roller is supported in the cantilevered state only on one end that is an end on the opposite side to the side where the tabs are located. There is accordingly no portion supporting the transfer roller on the side of the transfer roller where the tabs are located. This configuration does not cause any collision of the tabs with such a portion. This more certainly prevents the collision of the tabs with the portion supporting the transfer roller, as well as the collision of the tabs with the outer circumferential face of the transfer roller. As a result, this more effectively prevents the tabs from being bent or broken.

Aspect 6. In the winding apparatus described in above Aspect 1, the position adjustment unit may comprise a shaft rod that extends in the rotation axis direction; a bearing that is mounted to the transfer roller in a state that the shaft rod is inserted in the bearing, and supports the transfer roller in a freely rotatable state relative to the shaft rod; and a set collar that restricts a sliding move of the bearing along the shaft rod and allows switching between a state of restricting the sliding move and a state of releasing the restricted sliding move, wherein the position adjustment unit may regulate the relative positional relationship by slidingly moving the bearing along the shaft rod.

The winding apparatus of above Aspect 6 enables the position adjustment unit to be implemented by a relatively simple configuration. This reduces, for example, the costs required for manufacture of the winding apparatus and for maintenance of the winding apparatus and achieves downsizing of the apparatus and the like.

Additionally, the configuration of above Aspect 6 enables the transfer roller to be slidingly moved continuously (in analog). This configuration accordingly enables the relative positional relationship between the electrode sheet and the transfer roller to be finely regulated and thereby enables the relative positional relationship to be set more appropriately.

The technical features relating to the respective aspects described above may be combined appropriately. For example, the technical features relating to Aspect 5 described above may be combined with the technical features relating to Aspect 2 described above.

### BRIEF DESCRIPTION OF DRAWINGS

FIG. 1 is a schematic perspective view illustrating the schematic configuration of a battery element;

FIG. 2 is a schematic plan view illustrating the schematic configuration of a cathode sheet;

FIG. 3 is a schematic plan view illustrating the schematic configuration of an anode sheet;

FIG. 4 is a schematic plan view illustrating formation of tabs of the cathode sheet by a cutting process of cutting a cathode sheet material;

FIG. 5 is a schematic plan view illustrating formation of tabs of the anode sheet by a cutting process of cutting an anode sheet material;

FIG. 6 is a schematic configuration diagram illustrating a winding apparatus;

FIG. 7 is a schematic configuration diagram illustrating a winding unit;

FIG. 8 is a schematic perspective view illustrating a roller device and its periphery;

FIG. 9 is a sectional view taken on a line J-J in FIG. 8;

FIG. 10 is a schematic plan view illustrating a positional relationship between a trough portion of the electrode sheet and a width direction edge portion of a transfer roller;

FIG. 11 is a schematic front view illustrating a correction module;

FIG. 12 is a schematic configuration diagram illustrating the winding unit when separator sheets are placed in a clearance of a winding core;

FIG. 13 is a schematic configuration diagram illustrating the winding unit when the separator sheets are cut;

FIG. 14 is a schematic configuration diagram illustrating the winding unit at the time of termination of winding of the electrode sheets and the like;

FIG. 15 is a schematic perspective view illustrating a roller device and its periphery to show a position adjustment mechanism according to one or more embodiments;

FIG. 16 is a sectional view taken on a line K-K in FIG. 15;

FIG. 17 is a schematic perspective view illustrating a roller device to show a position adjustment mechanism according to one or more embodiments;

FIG. 18 is a partly broken front view illustrating a roller device to show a transfer roller according to one or more embodiments,

FIG. 19 is a partly broken front view illustrating a roller device to show a transfer roller according to one or more embodiments; and

FIG. 20 is a schematic perspective view illustrating a roller device and its periphery to show a transfer roller supported in a cantilevered state according to one or more embodiments.

### DETAILED DESCRIPTION OF EMBODIMENTS

The following describes embodiments with referring to the drawings. The configuration of a lithium-ion battery element that is a winding element obtained by a winding apparatus is described first.

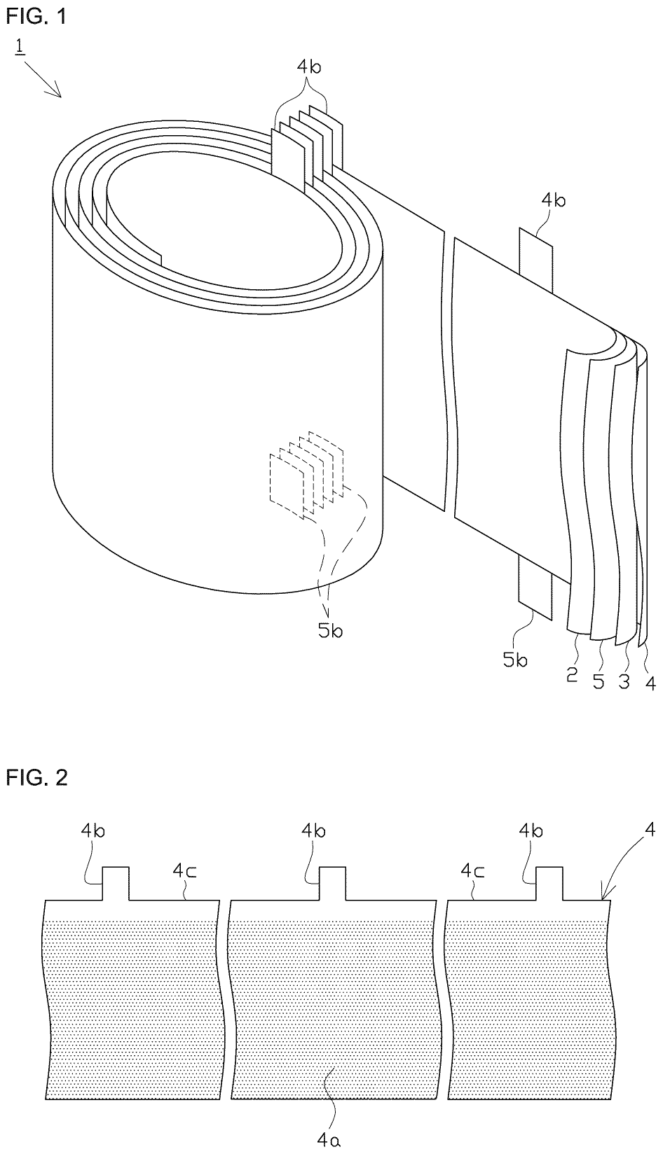

As shown in FIG. 1, a lithium-ion battery element 1 (hereinafter simply referred to as “battery element 1”) is manufactured by winding a cathode sheet (positive electrode sheet) 4 and an anode sheet (negative electrode sheet) 5 that are overlaid with each other via two separators 2 and 3. According to one or more embodiments, each of the cathode sheet 4 and the anode sheet 5 corresponds to the “electrode sheet”. One folded-back separator sheet may be used in place of the two separator sheets 2 and 3. In the description below, the separator sheets 2 and 3 and the electrode sheets 4 and 5 may be collectively referred to as “respective sheets 2 to 5” for convenience of explanation.

The separator sheets 2 and 3 are respectively formed in belt shapes having identical widths and are made of an insulating material, such as polypropylene (PP), in order to prevent the different electrode sheets 4 and 5 from coming into contact with each other and causing a short circuit.

The respective electrode sheets 4 and 5 are thin plate-like metal sheets. For example, an aluminum foil sheet is used for the cathode sheet 4, and for example, a copper foil sheet is used for the anode sheet 5. The respective electrode sheets 4 and 5 are formed to be relatively thin-walled (for example, the thickness of 5 to 50 μm or 10 to 30 μm).

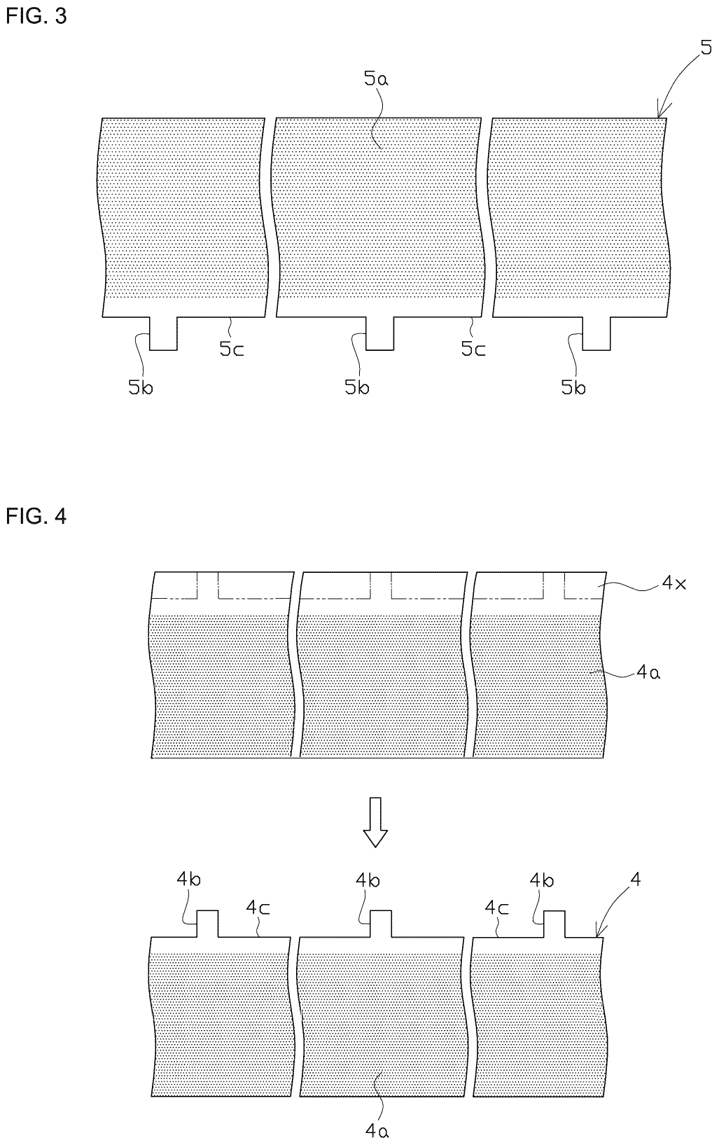

Additionally, as shown in FIG. 2 and FIG. 3, each of the electrode sheets 4 and 5 includes an electrode main body 4a or 5a and tabs 4b or 5b.

Each of the electrode main bodies 4a and 5a has a width substantially equal to the widths of the separator sheets 2 and 3, and an active material is applied on both a surface and a rear face of each of the electrode main bodies 4a and 5a. A cathode active material (positive electrode active material; for example, lithium manganate particles) is applied on the electrode main body 4a of the cathode sheet 4 (areas where the active material is applied are shown by dotted patterns in FIG. 2, FIG. 3 and the like). An anode active material (negative electrode active material; for example, active carbon) is applied on the electrode main body 5a of the anode sheet 5. Such configuration allows for ion exchange between the cathode sheet 4 and the anode sheet 5 via the active materials. FIG. 2 and FIG. 3 illustrate the configurations that the active material is not applied in some parts of the electrode main body 4a or 5a (for example, edge portions in a width direction). In a modified configuration, however, the active material may be applied on the whole area of the electrode main body 4a or 5a.

A plurality of the tabs 4b or 5b are protruded from the edge portions in the width direction of the electrode main body 4a or 5a and are disposed at intervals along a longitudinal direction of the electrode main body 4a or 5a. According to one or more embodiments, the tabs 4b of the cathode sheet 4 are protruded from one end in the width direction of the electrode main body 4a, and the tabs 5b of the anode sheet 5 are protruded from the other end in the width direction of the electrode main body 5a. According to a modification, however, the respective tabs 4b and 5b may be configured to be protruded from respective one ends on the same side of the electrode main bodies 4a and 5a.

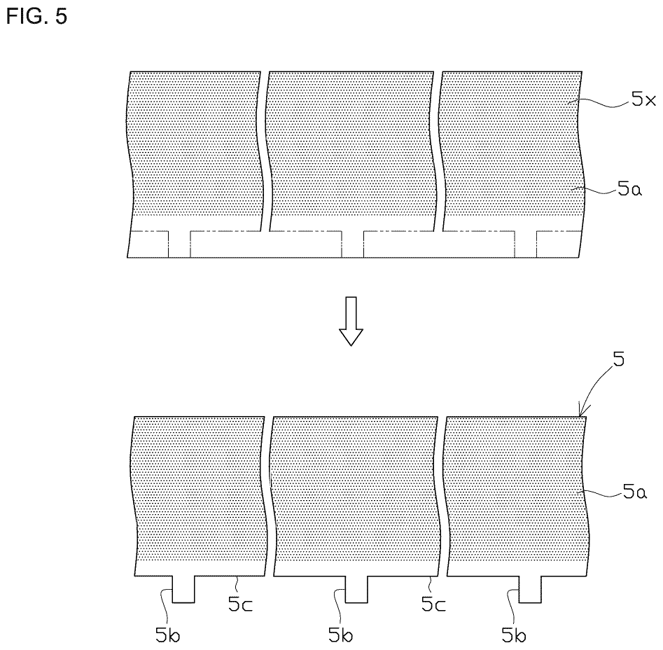

As shown in FIG. 4 and FIG. 5, the tabs 4b of the cathode sheet 4 are formed by a cutting process of cutting a cathode sheet material 4x in a belt shape having a cathode active material applied on a surface thereof by using a laser, a die or the like (for example, cutting the cathode sheet material 4x along two-dot chain lines shown in FIG. 4). Similarly, the tabs 5b of the anode sheet 5 are formed by a cutting process of cutting an anode sheet material 5x in a belt shape having an anode active material applied on a surface thereof. Accordingly, a trough portion 4c or 5c that is a width direction edge portion of the electrode main body 4a or 5a extended along the longitudinal direction of the electrode sheet 4 or 5 and that is located between the tabs 4b or 5b, is configured by a cut surface formed by the cutting process described above. The trough portion 4c or 5c configured by the cut surface may have burrs or the like and may be rough. According to one or more embodiments, each of the cathode sheet material 4x and the anode sheet material 5x corresponds to the “electrode sheet material”.

A process of obtaining a lithium-ion battery places the battery element 1 in a non-illustrated battery container (case) that is made of a metal and that is in a cylindrical shape, and respectively bundles the tabs 4b together and the tabs 5b together. As occasion demands, the process respectively welds the bundled tabs 4b and the bundled tabs 5b. The process subsequently connects the bundled tabs 4b with a cathode terminal component (positive electrode terminal component; not shown), similarly connects the bundled tabs 5b with an anode terminal component (negative electrode terminal component; not shown), and provides the respective terminal components at such positions as to close respective end openings of the battery container, so as to obtain the lithium-ion battery.

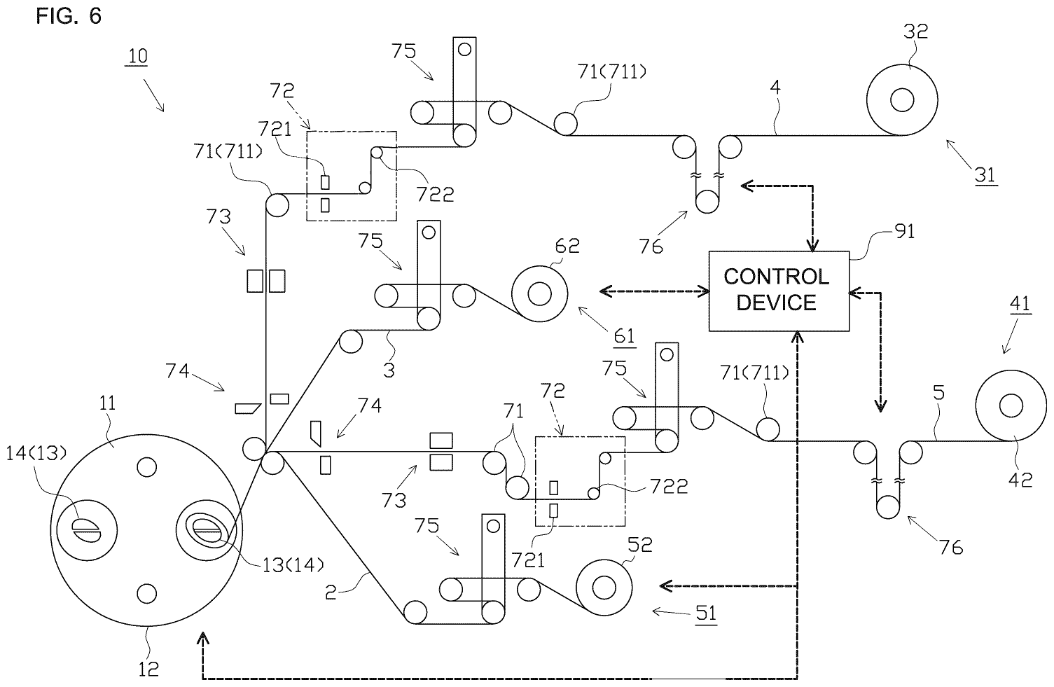

The following describes the winding apparatus 10 used to manufacture the battery element 1. As shown in FIG. 6, the winding apparatus 10 includes a winding unit 11 configured to wind the respective sheets 2 to 5; a cathode sheet feed mechanism (positive electrode sheet feed mechanism) 31 configured to feed the cathode sheet 4 to the winding unit 11; an anode sheet feed mechanism (negative electrode sheet feed mechanism) 41 configured to feed the anode sheet 5 to the winding unit 11; separator feed mechanisms 51 and 61 respectively configured to feed the separator sheet 2 and the separator sheet 3 to the winding unit 11; and a control device 91. The operations of the various mechanisms, such as the winding unit 11 and the respective feed mechanisms 31, 41, 51 and 61 in the winding apparatus 10 are controlled by the control device 91.

The cathode sheet feed mechanism 31 includes a cathode sheet roll 32 that is obtained by winding the cathode sheet 4 in a roll form. The cathode sheet roll 32 is supported in a freely rotatable manner, and the cathode sheet 4 is appropriately pulled out from this cathode sheet roll 32.

The cathode sheet feed mechanism 31 includes roller devices 71, a positional relationship maintaining mechanism 72, a sheet insertion mechanism 73, a sheet cutting cutter 74, a tension applying mechanism 75 and a buffer mechanism 76.

The roller device 71 is a device including, for example, a transfer roller 711 that is provided with the cathode sheet 4 placed on an outer circumferential face thereof and that is configured to specify a transfer path of the cathode sheet 4. A plurality of the roller devices 71 (the transfer rollers 711) are provided along the transfer path of the cathode sheet 4. The configuration of the roller device 71 will be described later in detail.

The positional relationship maintaining mechanism 72 is disposed at a position immediate upstream of the transfer roller 711 along the transfer path of the cathode sheet 4 and is configured to maintain the positional relationship between the outer circumferential face of the transfer roller 711 and the cathode sheet 4 placed thereon, in an appropriate state. The configuration of the positional relationship maintaining mechanism 72 will also be described later.

The sheet insertion mechanism 73 is configured to feed the cathode sheet 4 to the winding unit 11, while holding the cathode sheet 4.

The sheet cutting cutter 71 is configured to cut the cathode sheet 4. The cathode sheet 4 is cut in the state that the cathode sheet 4 is held by the sheet insertion mechanism 73. The sheet cutting cutter 74 is separable from the transfer path of the cathode sheet 4, so as not to interfere with feeding of the cathode sheet 4 by the sheet insertion mechanism 73.

The tension applying mechanism 75 is configured to apply a tensile force to the cathode sheet 4 and is provided with a plurality of rollers (for example, dancer rollers). Controlling the operations of these rollers by the control device 91 enables the tensile force applied to the cathode sheet 4 by the tension applying mechanism 75 to be regulated. According to one or more embodiments, the tension applying mechanism 75 is configured to continuously apply a constant tensile force to the cathode sheet 4. The rollers included in the tension applying mechanism 75 may have a similar or identical configuration to that of the transfer roller 711, in terms of the relative positional relationship to the cathode sheet 4.

The buffer mechanism 76 includes, for example, a pair of driven rollers and a lifting roller that is provided between the two driven rollers to be displaceable in a vertical direction, and is configured to temporarily retain the cathode sheet 4. The rollers included in the buffer mechanism 76 may have a similar or identical configuration to that of the transfer roller 711, in terms of the relative positional relationship to the cathode sheet 4.

The anode sheet feed mechanism 41 includes an anode sheet roll 42 that is obtained by winding the anode sheet 5 in a roll form and that is located on a most upstream side thereof. The anode sheet roll 42 is supported in a freely rotatable manner, and the anode sheet 5 is appropriately pulled out from this anode sheet roll 42.

Roller devices 71, a positional relationship maintaining mechanism 72, a sheet insertion mechanism 73, a sheet cutting cutter 74, a tension applying mechanism 75, a buffer mechanism 76 and the like are provided in the middle of a transfer path of the anode sheet 5 from the anode sheet roll 42 to the winding unit 11, as in the transfer path of the cathode sheet 4. These components are similar to those provided in the transfer path of the cathode sheet 4, except that these components function with regard to the anode sheet 5.

The separator feed mechanism 51 and the separator feed mechanism 61, on the other hand, respectively include a separator roll 52 and a separator roll 62 that are respectively obtained by winding the separator sheet 2 and the separator sheet 3 in roll forms. The separator rolls 52 and 62 are respectively supported in a freely rotatable manner, and the separator sheets 2 and 3 are appropriately pulled out from the respective separator rolls 52 and 62.

Like the electrode sheet feed mechanisms 31 and 41, each of the separator feed mechanisms 51 and 61 is further provided with a tension applying mechanism 75. These tension applying mechanisms 75 are similar to the tension applying mechanism 75 provided in the cathode sheet feed mechanism 31, except that these mechanisms 75 function with regard to the separator sheets 2 and 3.

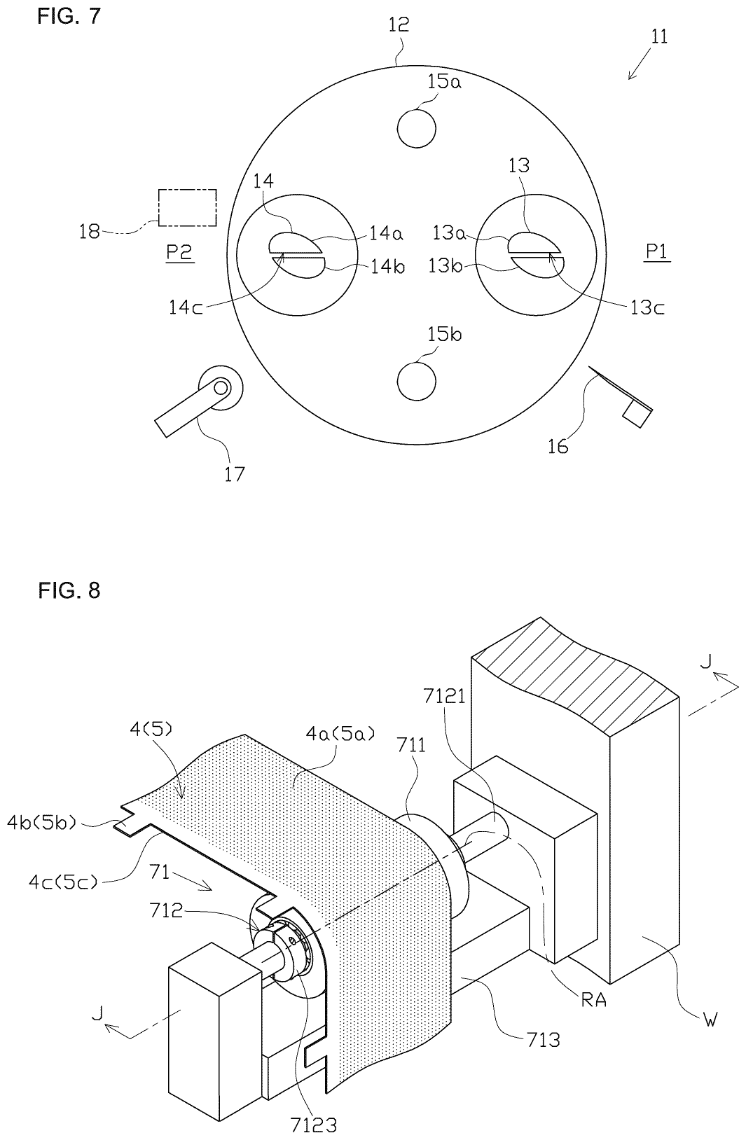

The following describes the configuration of the winding unit 11. As shown in FIG. 7, the winding unit 11 includes a turret 12 provided with two disk-shaped tables that are opposed to each other and that are configured to be rotatable by a non-illustrated driving mechanism; two winding cores 13 and 14 disposed at an interval of 180 degrees in a rotating direction of the turret 12; two support rollers 15a and 15b disposed at positions shifted by approximately 90 degrees from the respective winding cores 13 and 14 in the rotating direction of the turret 12; a separator cutter 16; a pressing roller 17 configured to press the respective sheets 2 to 5 immediately before termination of winding; and a tape attaching mechanism 18 configured to attach a predetermined fixation tape. The winding unit 11 is further provided with, for example, a demounting device (not shown) that is configured to demount the battery element 1 from the winding core 13 or 14 and that is located in a periphery of a demounting position P2 described later.

Each of the winding cores 13 and 14 is used to wind up the respective sheets 2 to 5 on an outer circumferential face thereof and is configured to be rotatable about a center axis thereof as a rotation axis by a non-illustrated driving mechanism. The amount of rotation of each of the winding cores 13 and 14 is detectable by a non-illustrated encoder, and information with regard to the amount of rotation is input from the encoder into the control device 91.

Each of the winding cores 13 and 14 is provided to be protruded and retreated relative to one of the tables configuring the turret 12 along an axial direction of the turret 12 (a depth direction of the sheet surface of FIG. 7). When each of the winding cores 13 and 14 is protruded from one of the tables, a leading end of the winding core 13 or 14 is inserted into a receiving hole formed in the other table, and the winding core 13 or 14 is supported in a rotatable state by both the tables.

Additionally, each of the winding cores 13 and 14 is configured to be in a non-circular shape in a cross section perpendicular to a rotation axis thereof. According to one or more embodiments, each of the winding cores 13 and 14 is in an elliptical shape in the cross section perpendicular to the rotation axis thereof. Since each of the winding cores 13 and 14 is in the non-circular shape in the cross section, even when the winding core 13 or 14 is rotated at a constant speed, the respective sheets 2 to 5 are fed to the winding core 13 or 14 at accelerating or decelerating speed. Immediately after a start of winding of the respective sheets 2 to 5, the respective sheets 2 to 5 are fed to the winding core 13 or 14 at accelerating speed. Immediately before termination of winding of the respective sheets 2 to 5, the respective sheets 2 to 5 are fed to the winding core 13 or 14 at decelerating speed.

Furthermore, each winding core 13 (14) includes a pair of core pieces 13a and 13b (14a and 14b) extended along the direction of the rotation axis thereof (the depth direction of the sheet surface of FIG. 7). A clearance 13c (14c) is formed between the core pieces 13a and 13b (14a and 14b). A chuck mechanism (not shown) configured to clamp the separator sheets 2 and 3 placed in the clearance 13c (14c) is disposed at a location where the clearance 13c (14c) of the winding core 13 (14) is formed.

Moreover, each of the winding cores 13 and 14 is configured to be turnable and movable between a winding position P1 and a demounting position P2 with the rotation of the turret 12. The winding position P1 denotes a position where the winding core 13 or 14 is located at the time of winding up the respective sheets 2 to 5. The demounting position P2 denotes a position where the winding core 13 or 14 is located at the time of demounting the respective sheets 2 to 5 (i.e., the battery element 1) after winding.

Each of the support rollers 15a and 15b is configured to catch and support the respective sheets 2 to 5 between the winding core 13 or 14, which is moved to the demounting position P2, and the feed mechanisms 31, 41, 51 and 61 described above.

The separator cutter 16 is configured to cut the separator sheets 2 and 3. The pressing roller 17 is configured to press the wound-up respective sheets 2 to 5.

The tape attaching mechanism 18 is configured to attach the fixation tape to respective terminal ends of the separator sheets 2 and 3 after completion of winding of the respective sheets 2 to 5.

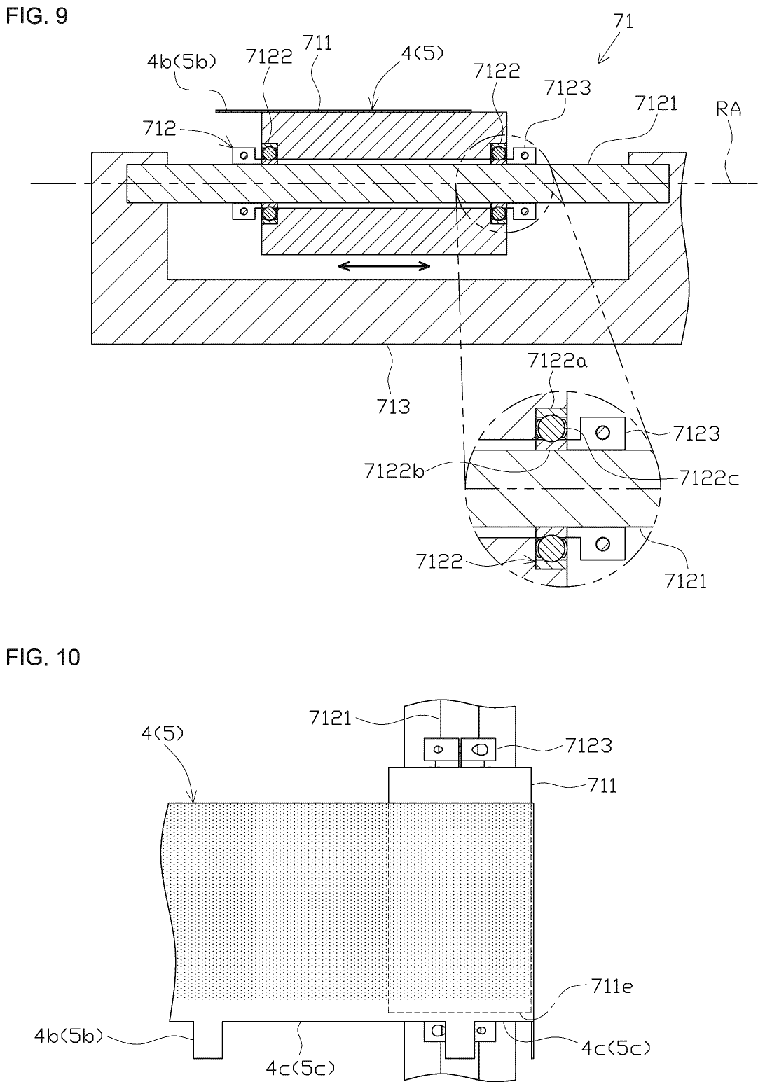

The following describes the roller device 71. As shown in FIG. 8 and FIG. 9, the roller device 71 includes a transfer roller 711, a position adjustment mechanism 712 and a holder 713. According to one or more embodiments, the position adjustment mechanism 712 configures the “position adjustment unit”.

As described above, the transfer roller 711 has the electrode sheet 4 or 5 placed on an outer circumferential face thereof and serves to specify the transfer path of the electrode sheet 4 or 5. The transfer roller 711 is in a cylindrical shape and is configured to be freely rotatable about a rotation axis RA. According to one or more embodiments, the outer circumferential face of the transfer roller 711 specifically denotes a surface having the electrode sheet 4 or 5 placed thereon to come into contact with the electrode sheet 4 or 5.

According to one or more embodiments, among a plurality of roller devices 71 respectively including the transfer rollers 711, at least one transfer roller 711 has the electrode sheet 4 or 5 that is placed thereon and that is transferred in a horizontal direction or in an oblique horizontal direction at a position immediately upstream of the one transfer roller 711 along a transfer direction of the electrode sheet 4 or 5. At the position immediately upstream of this transfer roller 711, the tabs 4b or 5b are likely to sag by means of the gravity.

The position adjustment mechanism 712 denotes a mechanism configured to adjust the position of the transfer roller 711 along the direction of the rotation axis RA of the transfer roller 711 (a direction of a thick arrow shown in FIG. 9). The position adjustment mechanism 712 includes a shaft rod 7121, bearings 7122, and set collars 7123.

The shaft rod 7121 extends in the direction of the rotation axis RA, and respective ends of the shaft rod 7121 are supported by the holder 713. According to one or more embodiments, the shaft rod 7121 is fixed to the holder 713 and is configured not to be rotatable about the rotation axis RA. According to a modification, however, the shaft rod 7121 may be configured to be rotatable relative to the holder 713 about the rotation axis RA.

The bearings 7122 are provided between the shaft rod 7121 and the transfer roller 711 and are configured to support the transfer roller 711 in a freely rotatable state relative to the shaft rod 7121. One bearing 7122 is mounted to each of respective ends of the transfer roller 711 in the direction of the rotation axis RA, in such a state that a center axis of the bearing 7122 is aligned with the rotation axis RA. Each of the bearings 7122 includes an outer ring portion 7122a, an inner ring portion 7122b and rolling bodies 7122c.

The outer ring portion 7122a is in a ring-like shape and is mounted to the transfer roller 711 in such a state that a relative rotation of the outer ring portion 7122a about the rotation axis RA is restricted.

The inner ring portion 7122b is in a ring-like shape and is provided on an inner side of the outer ring portion 7122a to be coaxial with the outer ring portion 7122a. The shaft rod 7121 is inserted through the inner ring portion 7122b. This configuration enables the bearings 7122 and the transfer roller 711 to be slidingly movable along the shaft rod 7121.

The rolling bodies 7122c are in a spherical shape, and a plurality of the rolling bodies 7122c are disposed at equal intervals between the outer ring portion 7122a and the inner ring portion 7122b. Rolling the rolling bodies 7122c causes the outer ring portion 7122a to smoothly rotate relative to the inner ring portion 7122b. As a result, this configuration enables the transfer roller 711 to smoothly and freely rotate relative to the shaft rod 7121.

The set collar 7123 is a component or tool configured to fix the bearings 7122. In one or more embodiments, the set collar 7123 is configured to allow switching between a state that the sliding moves of the bearings 7122 and the transfer roller 711 along the shaft rod 7121 are restricted and a state that the restriction of the sliding moves is released or removed. The set collar 7123 is in a ring-like shape as a whole, and one set collar 7123 is disposed at each of the respective ends of the transfer roller 711 along the direction of the rotation axis RA.

The set collar 7123 includes a pair of base components that are respectively formed in a semicircular shape; and a threaded fastener configured to couple the two base components with each other and form a ring-like shape as a whole. A process of tightening the threaded fastener and clamping the shaft rod 7121 between the pair of base components fixes the set collar 7123 to the shaft rod 7121 and restricts the sliding moves of the set collar 7123 along the shaft rod 7121. A process of loosening the threaded fastener and removing the clamping of the shaft rod 7121 by the pair of base components, on the other hand, allows for the sliding moves of the set collar 7123 along the shaft rod 7121.

According to one or more embodiments, the sliding moves of the bearings 7122 and the transfer roller 711 along the shaft rod 7121 are restricted by tightening the threaded fastener to fix the set collars 7123 to the shaft rod 7121 in the state that both the set collars 7123 are in contact with the bearings 7122 (the inner ring portions 7122b thereof). The sliding moves of the bearings 7122 and the transfer roller 711 along the shaft rod 7121 are restricted in normal times, for example, at the time of manufacture of the battery element 1 (winding element)/

Loosening the threaded fastener, on the other hand, allows for the sliding moves of the bearings 7122 and the transfer roller 711 along the shaft rod 7121. The configuration of the set collar 7123 may be appropriately modified, altered or changed as long as the set collar 7123 serves to allow switching between the restriction of the sliding moves of the bearings 7122 and the transfer roller 711 along the shaft rod 7121 and the removal of the restrictions of the sliding moves.

The holder 713 serves to support respective ends of the shaft rod 7121 and thereby support the transfer roller 711 via the shaft rod 7121 and the like. According to one or more embodiments, the holder 713 is fixed to a predetermined mounting part W not to be movable.

The roller device 71 is configured as described above. The configuration of one or more embodiments enables a relative positional relationship between the transfer roller 711 and the electrode sheet 4 or 5 placed on the transfer roller 711 to be regulated by removing the restrictions of the sliding moves of the bearings 7122 and the transfer roller 711 and subsequently slidingly moving the bearings 7122 and the transfer roller 711 along the shaft rod 7121. According to one or more embodiments, the transfer roller 711 is set, such that the trough portion 4c or 5c is protruded from a width direction edge portion 711e in the outer circumferential face of the transfer roller 711 by regulating the relative positional relationship between the transfer roller 711 and the electrode sheet 4 or 5 placed on the transfer roller 711 (as shown in FIG. 10). According to one or more embodiments, on the other hand, the relative positional relationship between the transfer roller 711 and the electrode sheet 4 or 5 is set, such that a half area or more (preferably 80% or more) of the electrode main body 4a or 5a along the width direction is placed on the outer circumferential face of the transfer roller 711.

The following describes the positional relationship maintaining mechanism 72. The positional relationship maintaining mechanism 72 is configured to maintain the relative positional relationship between the outer circumferential face of the transfer roller 711 and the electrode sheet 4 or 5 placed on the outer circumferential face of the transfer roller 711, in an appropriate state, as described above. The configuration of one or more embodiments includes a positional relationship maintaining mechanism 72 corresponding to one of the transfer rollers 711 included in the cathode sheet feed mechanism 31 and a positional relationship maintaining mechanism 72 corresponding to one of the transfer rollers 711 included in the anode sheet feed mechanism 41. A plurality of the positional relationship maintaining mechanisms 72 may be provided along the transfer path of each of the electrode sheets 4 and 5. For example, the positional relationship maintaining mechanism 72 may be provided corresponding to each of the transfer rollers 711.

As shown in FIG. 6, the positional relationship maintaining mechanism 72 includes an edge sensor 721 configured to detect the position of the electrode sheet 4 or 5 in the width direction; a correction module 722 configured to correct a positional misalignment of the electrode sheet 4 or 5 in the width direction, based on the position detected by the edge sensor 721; and a correction actuator for meandering correction (not shown) configured to actuate the correction module 722. Information with regard to the position of the electrode sheet 4 or 5 in the width direction detected by the edge sensor 721 is output to the control device 91. According to one or more embodiments, the edge sensor 721 configures the “position detection unit”, and the correction module 722 configures the “correction unit”.

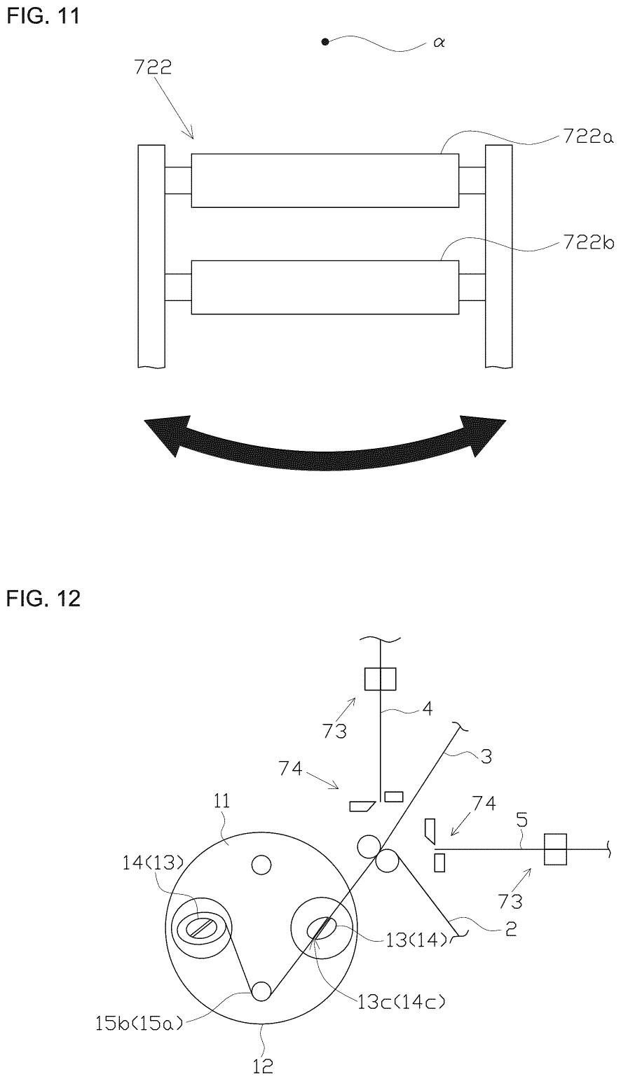

The correction module 722 includes a pair of upper and lower rollers 722a and 722b as shown in FIG. 11 and is configured to be pivotally rotatable about a pivot center a at the center above the upper roller 722a, as the center of pivotal rotation, by the correction actuator. The control device 91 controls the correction actuator to pivotally rotate the correction module 722 and thereby correct the positional misalignment of the electrode sheet 4 or 5. As a result, this configuration enables the state that the trough portion 4c or 5c is protruded from the width direction edge portion 711e in the outer circumferential face of the transfer roller 711 to be maintained. According to one or more embodiments, the correction module 722 also serves to correct the positional misalignment of the electrode sheet 4 or 5 in the width direction, such as to prevent the trough portion 4c or 5c from being excessively protruded from the width direction edge portion 711e in the outer circumferential face of the transfer roller 711, based on the position detected by the edge sensor 721.

The winding apparatus 10 configured as described above performs winding of the respective sheets 2 to 5 by a procedure described below. The procedure causes one winding core 13 (14) placed at the winding position P1 to be protruded from one of the tables of the turret 12 in the state that the separator sheets 2 and 3 are placed on the support roller 15a (15b) and the like, so as to place the separator sheets 2 and 3 in the clearance 13c (14c) of the winding core 13 (14) (as shown in FIG. 12). The procedure subsequently clamps the separator sheets 2 and 3 placed in the clearance 13c (14c) by the chuck mechanism described above. The procedure then rotates the one winding core 13 (14) by a predetermined number of times, so as to wind up the separator sheets 2 and 3 on the winding core 13 (14) by a predetermined amount.

The procedure then successively feeds the electrode sheets 4 and 5 to the one winding core 13 (14) by the respective sheet insertion mechanisms 73. The procedure subsequently rotates the winding core 13 (14) with feeding the respective sheets 2 to 5 to the winding core 13 (14), so as to overlay and wind the respective sheets 2 to 5 one upon another. Winding of the respective sheets 2 to 5 is performed in the state that the trough portion 4c or 5c is protruded from the width direction edge portion 711e in the outer circumferential face of the transfer roller 711.

Immediately after a start of winding of the respective sheets 2 to 5, the respective sheets 2 to 5 are fed to the winding core 13 or 14 at accelerating speed. After a certain time period has elapsed since the start of winding of the respective sheets 2 to 5, the winding core 13 or 14 is rotated at a constant speed, so that the respective sheets 2 to 5 are fed to the winding core 13 or 14 at accelerating or decelerating speed.

The procedure temporarily stops the rotation of the one winding core 13 (14) at the stage when the respective sheets 2 to 5 are wound up by a predetermined length. At the time when the respective sheets 2 to 5 are temporarily stopped, the respective sheets 2 to 5 are fed to the winding core 13 or 14 at decelerating speed. During the temporary stop of the respective sheets 2 to 5, the electrode sheets 4 and 5 are cut by the respective sheet cutting cutters 74.

The procedure subsequently moves the one winding core 13 (14) with the respective sheets 2 to 5 wound thereon to the demounting position P2 by rotating the turret 12. This causes the separator sheets 2 and 3 to be spanned over the support roller 15a (15b) and the like. Rotating the turret 12 also moves the other winding core 14 (13) to the winding position P1. A subsequent winding operation of the respective sheets 2 to 5 is performed on this other winding core 14 (13).

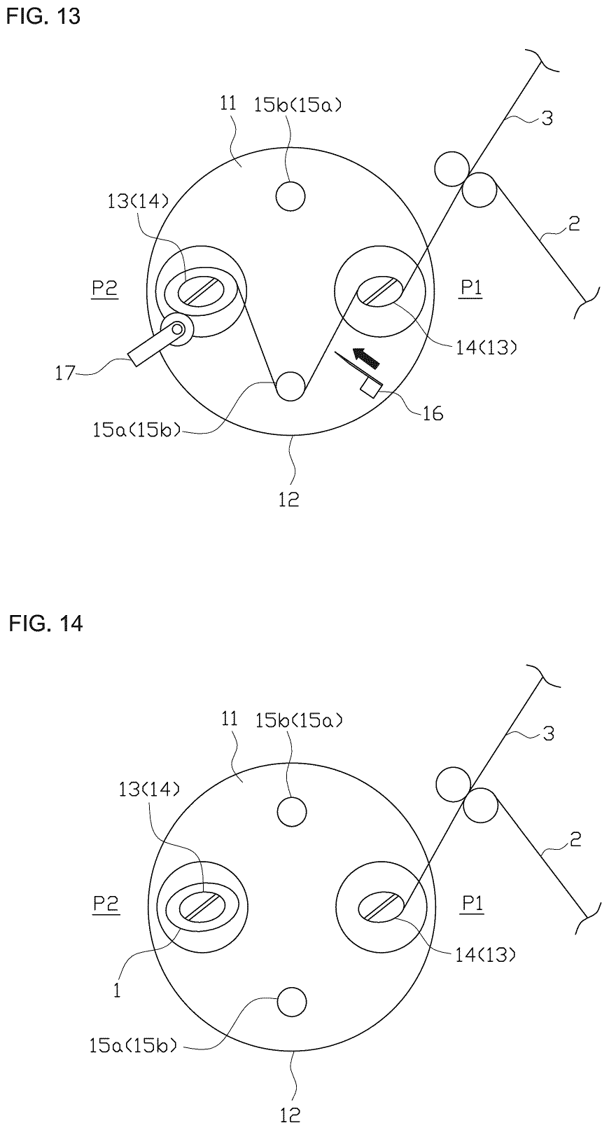

The procedure subsequently brings the pressing roller 17 close to the one winding core 13 (14) placed at the demounting position P2, causes the respective sheets 2 to 5 to be pressed by the pressing roller 17, and then cuts the separator sheets 2 and 3 by means of the separator cutter 16 (as shown in FIG. 13). The procedure subsequently rotates the one winding core 13 (14) to fully wind up the respective sheets 2 to 5 and attaches the fixation tape to the respective terminal ends of the separator sheets 2 and 3 by the tape attaching mechanism 18. This obtain the battery element 1 with the winding end treatment (as shown in FIG. 14). The obtained battery element 1 is demounted from the winding core 13 (14) by the demounting device described above.

As described above in detail, according to one or more embodiments, the transfer roller 711 is set such that the trough portion 4c or 5c is protruded from the width direction edge portion 711e of the transfer roller 711, when the position adjustment mechanism 712 is used to regulate the relative positional relationship between the transfer roller 711 and the electrode sheet 4 or 5. Accordingly, the transfer roller 711 is set such that the entire tabs 4b or 5b of the electrode sheet 4 or 5 placed on the transfer roller 711 are present at a position deviated from the outer circumferential face of the transfer roller 711, when the transfer roller 711 is viewed from a direction orthogonal to the rotation axis RA. The electrode sheets 4 and 5 are fed to the winding core 13 or 14 at accelerating or decelerating speed. This configuration more certainly prevents collision of the tabs 4b or 5b with the outer circumferential face of the transfer roller 711, accompanied with the swing motion of the tabs 4b or 5b, even under the condition that the swing motion of the tabs 4b or 5b is likely to occur. As a result, this configuration suppresses jumping of the tabs 4b or 5b caused by the collision of the tabs 4b or 5b with the outer circumferential face of the transfer roller 711 and thereby effectively prevents the tabs 4b or 5b from being bent or broken.

The configuration of preventing the collision of the tabs 4b or 5b with the outer circumferential face of the transfer roller 711 and thereby preventing the tabs 4b or 5b from being bent or broken enables the tabs 4b or 5b to be kept in good conditions with less damage. This accordingly improves the quality of the obtained battery element 1.

Furthermore, the configuration of providing the position adjustment mechanism 712 allows for handling of the various electrode sheets 4 and 5 having different widths or the like and thereby enhances the convenience.

Moreover, the positional relationship maintaining mechanism 72 (including the edge sensor 721 and the correction module 722) serves to maintain the state that the trough portion 4c or 5c is protruded from the width direction edge portion 711e of the transfer roller 711. Accordingly, this configuration more certainly prevents the collision of the tabs 4b or 5b with the outer circumferential face of the transfer roller 711. This further enhances the effect of preventing the tabs 4b or 5b from being bent or broken and further improves the conditions of the tabs 4b or 5b.

Additionally, according to one or more embodiments, the electrode sheet 4 or 5 transferred in the horizontal direction or in the oblique horizontal direction is placed on at least one transfer roller 711. This configuration makes the tabs 4b or 5b more likely to sag by means of the gravity at the position immediately upstream of this transfer roller 711. There is accordingly a higher risk of collision of the tabs 4b or 5b with the transfer roller 711. The configuration of setting the positional relationship between the electrode sheet 4 or 5 and the transfer roller 711 as described above, however, more certainly prevents the collision of the tabs 4b or 5b with the transfer roller 711 even under the condition that the tabs 4b or 5b are more likely to sag.

Furthermore, according to one or more embodiments, the tabs 4b or 5b are formed by the cutting process of cutting the electrode sheet material 4x or 5x, and the trough portion 4c or 5c is configured by the cut surface formed by the cutting process. This configuration makes the trough portion 4c or 5c more likely to be rough (in the state having burrs or the like) and may increase the risk of bending or breaking the tabs 4b or 5b due to the rough part running on the outer circumferential face of the transfer roller 711. The configuration of setting the positional relationship between the electrode sheet 4 or 5 and the transfer roller 711 as described above, however, more certainly prevents the rough part (for example, burrs or the like) from running on the outer circumferential face of the transfer roller 711, even in the rough state of the trough portion 4c or 5c. This further enhances the effect of preventing the tabs 4b or 5b from being bent or broken.

This configuration does not require any additional process of removing the rough part from the trough portion 4c or 5c (the cut surface), with a view to preventing the rough part from running on the outer circumferential face of the transfer roller 711. This reduces, for example, the cost required for manufacture of the battery element 1.

Moreover, according to one or more embodiments, the position adjustment mechanism 712 can be implemented by a relatively simple configuration. This reduces, for example, the costs required for manufacture of the winding apparatus 10 and for maintenance of the winding apparatus 10 and achieves downsizing of the apparatus and the like.

Additionally, the position adjustment mechanism 712 enables the transfer roller 711 to be slidingly moved continuously (in analog). This configuration accordingly enables the relative positional relationship between the electrode sheet 4 or 5 and the transfer roller 711 to be finely regulated and thereby enables the relative positional relationship to be set more appropriately.

The present disclosure is not limited to the description of the above embodiments but may be implemented, for example, by configurations described below. The present disclosure may also be naturally implemented by applications and modifications other than those illustrated below.

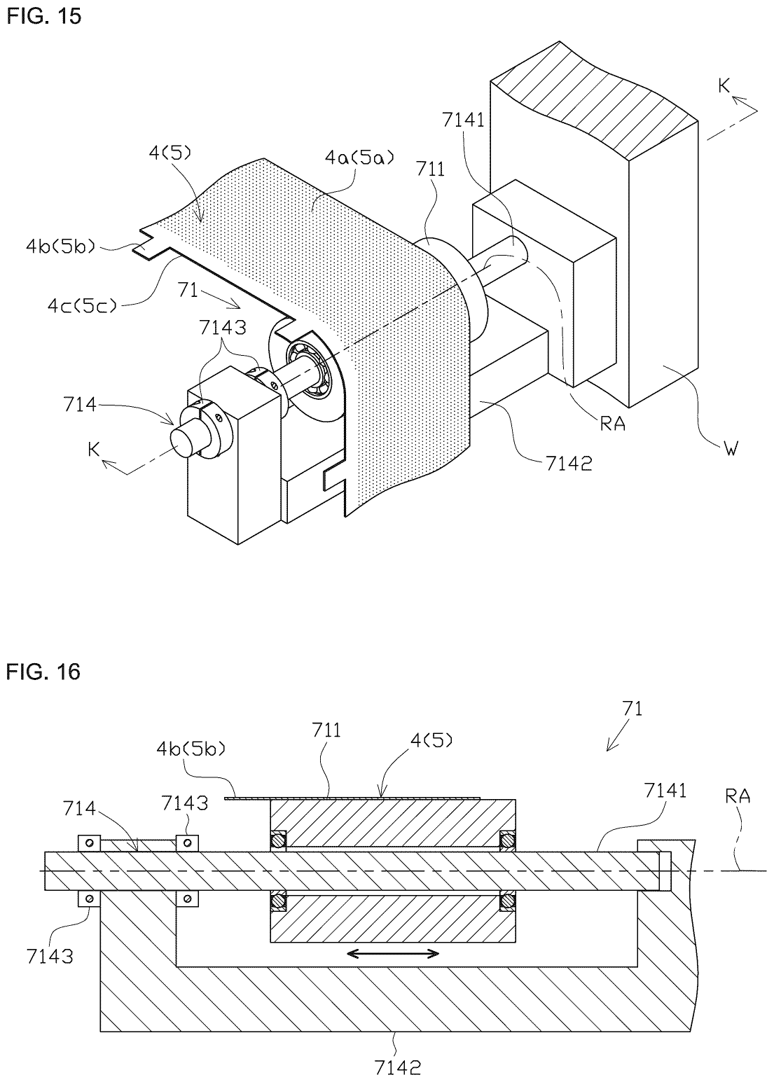

(a) The above embodiments are configured to regulate the relative positional relationship between the transfer roller 711 and the electrode sheet 4 or 5 placed on the transfer roller 711 by slidingly moving the bearings 7122 and the transfer roller 711 along the shaft rod 7121. As shown in FIG. 15 and FIG. 16, a modification may be configured to regulate the relative positional relationship between the transfer roller 711 and the electrode sheet 4 or 5 placed on the transfer roller 711 by making a shaft rod 7141 slidingly movable relative to a holder 7142 along the direction of the rotation axis RA. A position adjustment mechanism 714 adopted in this modification may accordingly include the shaft rod 7141 configured to support the transfer roller 711; and the holder 7142 configured to support the shaft rod 7141 to be slidingly movable along the direction of the rotation axis RA.

In the case of adopting this position adjustment mechanism 714, the modification may further use set collars 7143 serving to switch over between fixation of the shaft rod 7141 and cancellation of the fixation and may be configured to allow switching between a state of restricting the slide move of the shaft rod 7141 relative to the holder 7142 along the direction of the rotation axis RA and a state of removing the restriction of the sliding move. The set collars 7143 are, for example, fixed to the shaft rod 7141 in a state that the set collars 7143 are in contact with the holder 7142 along the direction of the rotation axis RA, so as to restrict the sliding move of the shaft rod 7141 relative to the holder 7142 along the direction of the rotation axis RA.

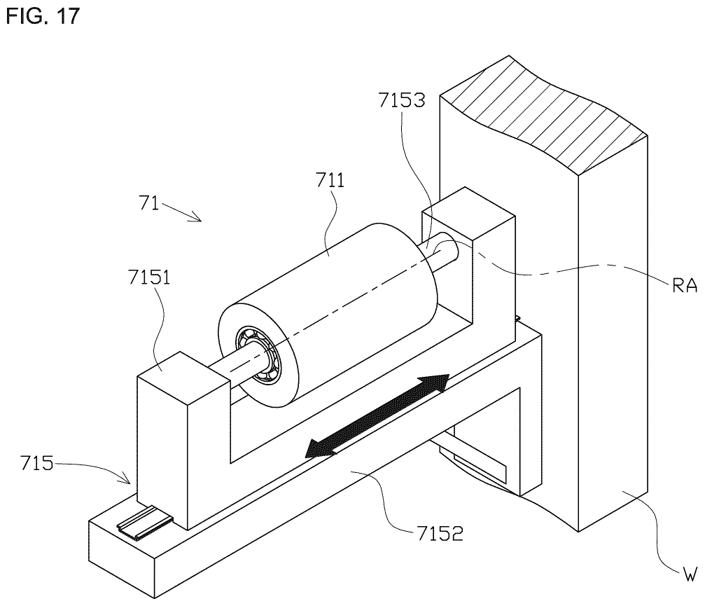

Furthermore, as shown in FIG. 17, another modification may be configured to regulate the relative positional relationship between the transfer roller 711 and the electrode sheet 4 or 5 placed on the transfer roller 711 by making a holder 7151 slidingly movable relative to a mechanism base portion 7152 serving as a base in the direction of the rotation axis RA. A position adjustment mechanism 715 adopted in this modification may accordingly include the holder 7151 configured to support the transfer roller 711 (via a shaft rod 7153 in this illustrated example); and the mechanism base portion 7152 configured to support the holder 7151 to be slidingly movable along the direction of the rotation axis RA.

According to another modification, the position adjustment mechanism may be configured by appropriately combining the technical features relating to the position adjustment mechanisms 712, 714 and 715 described above. For example, the position adjustment mechanism may be configured by making the transfer roller 711 slidingly movable along a shaft rod and further making the shaft rod slidingly movable relative to a holder along the direction of the rotation axis RA, such as to regulate the relative positional relationship between the electrode sheet 4 or 5 and the transfer roller 711 at a plurality of positions.

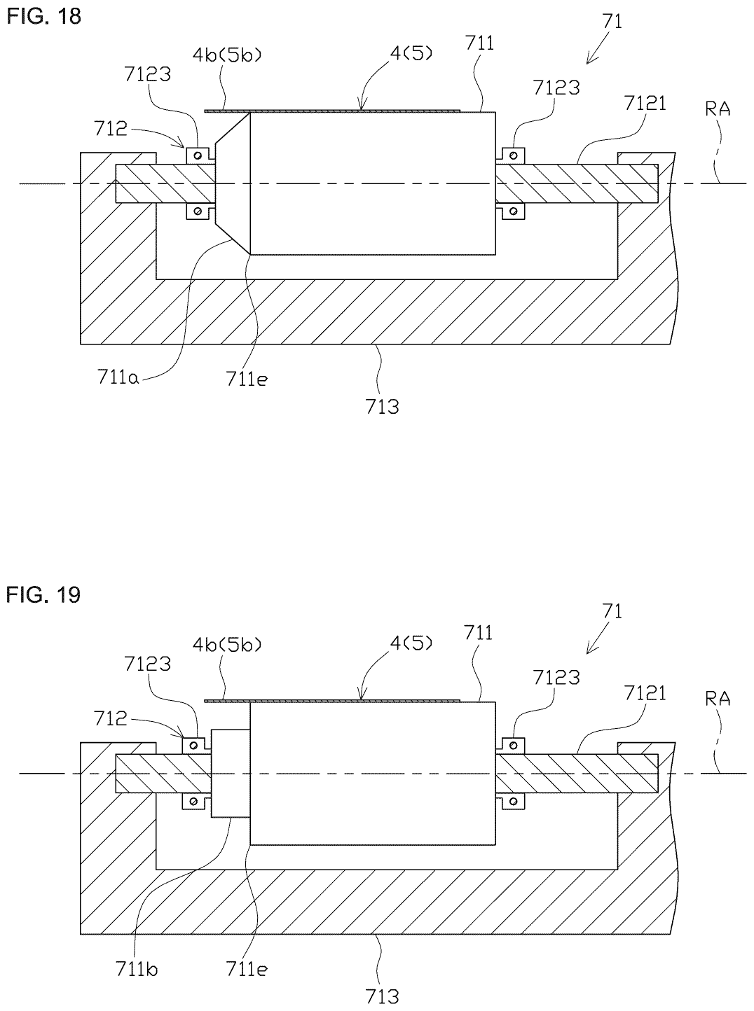

(b) The shape of the transfer roller 711 according to the embodiments described above is only illustrative and may be changed appropriately, as long as the shape of the transfer roller 711 allows for prevention of the collision of the tabs 4b or 5b with the outer circumferential face of the transfer roller 711. For example, as shown in FIG. 18, the transfer roller 711 may include a tapered portion 711a that has the diameter gradually reduced from the width direction edge portion 711e in the outer circumferential face toward one end in the direction of the rotation axis RA. In another example, as shown in FIG. 19, the transfer roller 711 may include a columnar portion 711b of a relatively small diameter that is protruded from the width direction edge portion 711e in the outer circumferential face toward one end in the direction of the rotation axis RA. Accordingly, the transfer roller 711 may include a portion that may overlap with the tabs 4b or 5b, when being viewed from the direction orthogonal to the rotation axis RA. In terms of preventing the collision of the tabs 4b or 5b, however, the transfer roller 711 having no such a portion that may overlap with the tabs 4b or 5b, when being viewed from the direction orthogonal to the rotation axis RA, may be used.

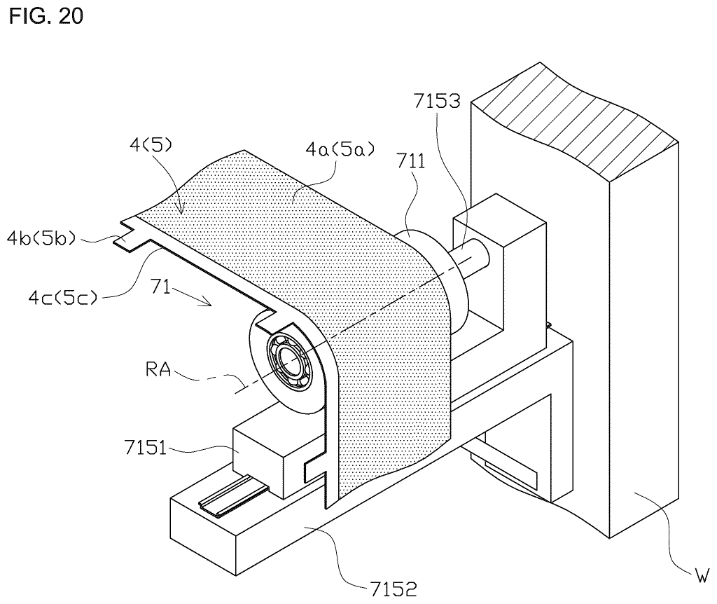

(c) According to the embodiments described above, the transfer roller 711 is supported in a double-end supporting state by the shaft rod 7121 on both the ends along the direction of the rotation axis RA. According to a modification, however, as shown in FIG. 20, the transfer roller 711 may be supported in a cantilevered state by a shaft rod 7153 on only one end along the direction of the rotation axis RA, which is an end on an opposite side to the end where the tabs 4b or 5b are located. In this illustrated example, the modification is configured to regulate the relative positional relationship between the transfer roller 711 and the electrode sheet 4 or 5 by causing the shaft rod 7153 to be supported by a holder 7151 and making the holder 7151 slidingly movable relative to a mechanism base portion 7152 along the direction of the rotation axis RA.

In this modified configuration of supporting the transfer roller 711 in the cantilevered state as described above, there is no portion supporting the transfer roller 711 on the side of the transfer roller 711 where the tabs 4b or 5b are located. This configuration accordingly does not cause any collision of the tabs 4b or 5b with such a portion. This more certainly prevents the collision of the tabs 4b or 5b with the portion supporting the transfer roller 711, as well as the collision of the tabs 4b or 5b with the outer circumferential face of the transfer roller 711. As a result, this more effectively prevents the tabs 4b or 5b from being bent or broken.

(d) According to the embodiments described above, the tabs 4b or 5b are formed by the cutting process of cutting the electrode sheet material 4x or 5x (i.e., formed tabs). The configuration of the tabs is, however, not limited to that of the embodiments. The tabs 4b or 5b may be, for example, joined with the electrode main body 4a or 5a by welding (i.e., welded tabs). The welded tabs often have relatively thick wall and are thus less likely to have swing motion. The formed tabs, on the other hand, often have relatively thin wall and are thus more likely to have swing motion. Accordingly, the winding apparatus 10 of the embodiments described above is especially effective for the electrode sheet 4 or 5 provided with the formed tabs.

(e) According to the embodiments described above, the positional relationship maintaining mechanism 72 is disposed at the position immediately upstream of the transfer roller 711 along the transfer path of the electrode sheet 4 or 5. The position where the positional relationship maintaining mechanism 72 is placed may, however, be changed appropriately. For example, the positional relationship maintaining mechanism 72 may be disposed at a position immediately downstream of the transfer roller 711 along the transfer path of the electrode sheet 4 or 5.

(f) According to the embodiments described above, the winding unit 11 is configured to include the two winding cores 13 and 14. The winding unit 11 may, however, be configured to include only one winding core or may be configured to include three or more winding cores.

Furthermore, the outer circumferential shape of the winding core is not limited to the shape described in the above embodiments. For example, the outer circumferential face of the winding core may have a circular shape or an elliptical shape in a cross section perpendicular to the rotation axis of the winding core. Moreover, the winding core may be configured without any clearance between core pieces. Additionally, the winding core may be configured to have a core component in a tubular shape that is provided in the outer circumference of the winding core and that is configured to allow the electrode sheet 4 or 5 or the like to be wound thereon.

(g) According to the embodiments described above, the lithium-ion battery element 1 is manufactured by the winding apparatus 10. The winding element manufactured by the winding apparatus 10 is, however, not limited to this battery element 1. For example, a winding element of an electrolytic capacitor or the like may be manufactured.

(h) The materials of the separator sheets 2 and 3 and of the electrode sheets 4 and 5 are not limited to those described in the above embodiments but may be changed appropriately. The active materials applied on the electrode sheets 4 and 5 may also be changed.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . lithium-ion battery element (winding element), 2, 3 . . . separator sheets, 4 . . . cathode sheet (electrode sheet), 5 . . . anode sheet (electrode sheet), 4a, 5a . . . electrode main bodies, 4b, 5b . . . tabs, 4c, 5c . . . trough portions, 10 . . . winding apparatus, 13, 14 . . . winding cores, 711 . . . transfer roller, 712, 714, 715 . . . position adjustment mechanisms (position adjustment unit), 721 . . . edge sensor (position detection unit), 722 . . . correction module (correction unit), 7121 . . . shaft rod, 7122 . . . bearing, 7123 . . . set collar

What is claimed is:

1. A winding apparatus that winds up a belt-shaped electrode sheet including an active material and a belt-shaped separator sheet made of an insulating material, the winding apparatus comprising:
a rotatable winding core to which the electrode sheet and the separator sheet are fed at accelerating or decelerating speed, and around which the electrode sheet and the separator sheet are wound;
a rotatable transfer roller that defines a transfer path of the electrode sheet and has an outer circumference face on which the electrode sheet is placed; and
a position adjustment unit that adjusts a position of the transfer roller along a rotation axis direction of the transfer roller, wherein
the electrode sheet comprises:
an electrode main body on which the active material is applied;
tabs protruded from a width direction edge portion of the electrode main body and disposed at intervals along a longitudinal direction of the electrode main body; and
a trough portion disposed between the tabs at the width direction edge portion, and
the position adjustment unit adjusts a relative positional relationship between the transfer roller and the electrode sheet placed on the transfer roller such that the trough portion protrudes from a width direction edge portion in an outer circumferential face of the transfer roller.

2. The winding apparatus according to claim 1, further comprising:
an edge sensor that detects a position in a width direction of the electrode sheet placed on the transfer roller; and
a correction unit that corrects a positional misalignment in the width direction of the electrode sheet while the electrode sheet is being wound on the winding core, based on the position detected by the edge sensor, wherein
the edge sensor and the correction unit maintain a state in which the trough portion protrudes from the width direction edge portion in the outer circumferential face of the transfer roller.

3. The winding apparatus according to claim 1, wherein
the electrode sheet is placed on the transfer roller after being transferred in a horizontal direction or in an oblique horizontal direction at a position immediately upstream of the transfer roller along a transfer direction of the electrode sheet.

4. The winding apparatus according to claim 1, wherein
the tabs are formed by cutting a belt-shaped electrode sheet material on which an active material is applied, and
the trough portion is configured by a cut surface of the electrode sheet material.

5. The winding apparatus according to claim 1, wherein
the transfer roller is supported in a cantilevered state only on one end in the rotation axis direction, the one end being on an opposite side to a side where the tabs are located.

6. The winding apparatus according to claim 1, wherein
the position adjustment unit comprises:
a shaft rod that extends in the rotation axis direction;
a bearing that is mounted to the transfer roller in a state that the shaft rod is inserted in the bearing, and supports the transfer roller in a freely rotatable state relative to the shaft rod; and
a set collar that restricts a sliding move of the bearing along the shaft rod and allows switching between a state of restricting the sliding move and a state of releasing the restricted sliding move, wherein
the position adjustment unit regulates the relative positional relationship by slidingly moving the bearing along the shaft rod.
